(19) United States
(12) Patent Application Publication
(10) Pub. No.: US 2018/0174092 A1
(43) Pub. Date: Jun. 21, 2018

(54) METHOD, SYSTEM, AND APPARATUS FOR MOBILE RECRUITMENT OF ON-DEMAND TEMP WORKERS

(71) Applicant: Benjamin Adegoke, Ham Lake, MN (US)

(72) Inventor: Benjamin Adegoke, Ham Lake, MN (US)

(21) Appl. No.: 15/380,636

(22) Filed: Dec. 15, 2016

(51) Int. Cl. G06Q 10/06; G06Q 10/10

(52) U.S. Cl. CPC G06Q 10/063116; G06Q 10/1053; G06Q 10/063118

(57) ABSTRACT

An application system comprises a client computing device, a temporary worker computing device, an online system connecting the computing devices, and a mobile recruitment vehicle. The vehicle is configured to facilitate conducting mass face-to-face recruiting of temporary workers, making the temporary workers readily available to clients for on-demand booking. The vehicle includes applicant and screener workstations. The applicant workstation is configured to receive applicant data. The screener workstation is configured to retrieve background check information related to the temporary worker, and to provide authentication information configured to allow the client computing device to access the online system, based on the results of screening, the background check information, and the applicant data.

### CROSS-REFERENCE TO RELATED APPLICATION(S)

This application claims priority to provisional application Ser. No. 62/268,344, filed on Dec. 16, 2015, which is hereby incorporated by reference in its entirety.

### BACKGROUND

The present invention relates generally to temp staffing, and more particularly to methods and systems for filling temporary work requests.

Staffing firms can obtain temporary workers in many ways and employers can book the workers in many ways. For example, staffing firms requires applicants to come to their offices, complete the application and wait for assignments. The employers in turn would call the staffing firms, go on their websites or use a vendor management system (VMS) to request for temporary workers.

Consequently, such processes do not offer an effective way for employers with constant fluctuating workforce to obtain the right temporary worker at the precise time they need them.

### SUMMARY

In at least one embodiment, the present invention is directed toward a mobile recruitment bus and an app (system) for quickly deploying temporary workers for various shifts to various businesses. In some embodiments, the present invention includes the use of a fleet of motor coaches (buses) for conducting mass face-to-face recruiting of temporary workers. In further or alternative embodiments, the present invention includes an on-demand booking app that can make temp workers readily available for businesses to book them on-demand.

In some embodiments, recruitment buses can provide 20 to 40 workstations arranged in the configuration in FIG. 4. This allows for quick recruitment of temporary workers by the mass. The buses can be driven and parked at strategic locations e.g. malls, university campuses, unemployment offices, large events, etc. The buses can have company logos and marketing messages to attract both businesses (clients) and applicants (temporary workers). Applicants can board the buses, locate an empty workstation, and take 10 minutes to complete an online application, then they can watch a five-minute orientation video and lastly, approach one of six screener's workstations located at the front of the bus for a ten-minute face-to-fact interview.

Once this interview is completed, the screener would either use the app to transmit the applicant's application to the corporate office for further screenings (e.g. electronic background checks) and if time permits, the screeners can initiate the electronic background checks on the applicants. If approved, the applicants are instantly alerted via email and/or text messages with instructions on accessing the app and are ready to begin picking up shifts for which they're qualified at businesses (clients) that fits their personal preferences (e.g. distance, rates, business reputations, notification lead time, etc.).

Clients can use the app to book qualified and vetted temporary workers when short-staffed. The app can have two distinct but integrated modules: employee scheduling and temp booking modules. Both modules can be used independent of each other: (1) a client can book a temporary worker after discovering gaps in the scheduling requirements, (2) a client can bypass the scheduling module and use the booking module to book a temporary worker.

When a client realizes a need for a temporary worker, the client can use a computing device to book a temporary worker that was recruited on the bus. The worker can get a notification for the request on the worker's computing device. The worker can accept the request or decline it. The worker can set maximum distance distant for shift, minimum rate and lead time before shift in the system. Further, the client can use the system to book a single worker or send a request to all matching workers within client's range. In some embodiments, the first worker to respond can lock the shift.

The present invention improves efficiency for the client to obtain a temporary worker. By positioning the recruiting bus at various strategic locations to attract competent workers, and vetting them quickly, a client can obtain the services of the worker just few hours after the worker was on the bus. Once the worker has completed a shift, the worker can submit a timecard to the client, the system can alert the client of new timecard for approval, denial or adjustment. Once approved, the system can facilitate payments of the worker.

The present summary is provided only by way of example, and not limitation. Other aspects of the present disclosure can be appreciated in view of the entirety of the present disclosure, including the entire text, claims, and accompanying figures.

### BRIEF DESCRIPTION OF THE DRAWINGS

FIG. 1 is schematic illustration of a network system according to the present invention. This network facilitates the use of a motor coach (bus) to conduct mass face-to-face recruiting of temporary workers and enable client with an on-demand booking app to book temporary workers in real time in accordance with one embodiment.

FIG. 2 is a method flowchart illustrating an example of an application process for temporary workers in accordance with one embodiment of the present invention.

FIG. 3 is a method flowchart illustrating an internal employee scheduling process by client, staff shortage tracks (gaps) and the booking of temporary workers to bridge the gaps in accordance with one embodiment.

FIG. 4 is a simplified floorplan illustrating an example of a bus layout for mobile recruitment of temporary workers in accordance with one embodiment.

FIG. 5 is a method flowchart illustrating a process for matching client's bookings with temporary workers in accordance with one embodiment.

FIG. 6 is a method flowchart illustrating a process for temporary workers locking shifts and wage payments in accordance with one embodiment.

FIGS. 7-12 are graphical user interface screens for use by clients.

FIG. 13 is a graphical user interface screen for use by temporary workers.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

The present disclosure concerns a system, method, and apparatus that enable the use of motor coaches (buses) to conduct mass face-to-face recruiting of temporary workers and enable clients with an app for booking the temporary workers on-demand in real time.

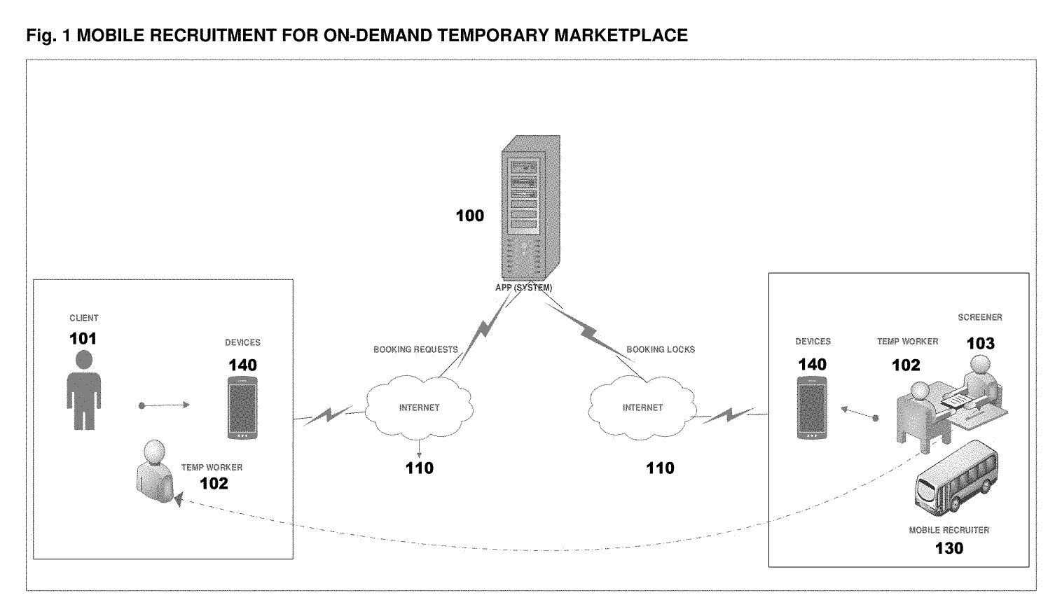

FIG. 1 illustrates an example of a network system that facilitates the use of motor coach (bus) to conduct mass face-to-face recruiting of temporary workers and enable client with an on-demand booking app to book temporary workers in real time in accordance with one embodiment. In the embodiment in FIG. 1, app system 100 is an online-based system designed to facilitate the business logic (applications and databases) for mobile recruitment and booking of temporary workers including vetting APIs of temporary workers, booking and matching processes of temporary workers and manage user access. Devices 140 computing devices (e.g. desktop computers, laptops, tablets, smartphones, smart watches), that can be used to access and interact with the app system 100 using the internet. The app system 100 can manage the applications and databases to aide in the administration of the Mobile Recruiter 130, it can facilitate account registrations of clients 101, interviews, vetting processes, account activations of temp workers 102, scheduling of internal client's 101 staff members, bookings of temp workers 102, matching of temp worker 102 with client 101 shift requirements in accordance with clients and temp workers' preferences, management of shift completions by temp worker 102 and payments of temp worker 102.

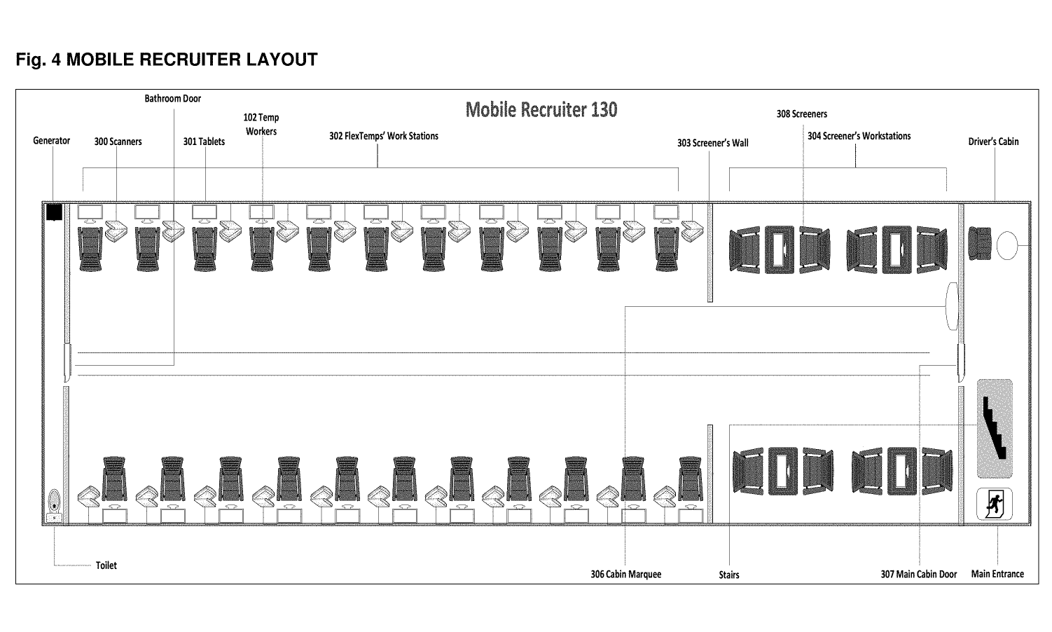

To provide further context for the preceding and later embodiments, Mobile Recruiter 130 is configured and laid out (as shown in FIG. 4) to ensure quick processing of mass temporary workers 102 in a timely fashion. The Mobile Recruiter can consist of 20 to 40 workstations, each with a desk, chair, a tablet, scanner and headphone. The temp worker workstations 302 are laid out facing the windows which are covered with shades. The front of the mobile recruiter consists of 4 to 6 screeners' 103 workstations 304 where face-to-face interviews are conducted with the temp workers 102. On the screeners' workstations 304 are tablets for conducting interviews with the temp workers 102. The mobile recruiter is parked in strategic places such as university campuses, popular malls, downtowns, unemployment offices, major event centers. Once a location has been determined, temp worker 102 can begin boarding the mobile recruiter 130. Each temp worker 102 can pick and sit at any unoccupied workstation 302, complete the application process that is managed by app system 100. The application process takes between 10 and 15 minutes. The temp worker 102 can be required to use the scanners 300 at their workstation 301 to scan their driver's license or any government issued identification into the app system 100. Data collected from the applicant at workstation 302 can include identity (and identification), qualifications, and contact information. Afterwards, the temp worker waits for their workstation's numbers to be flashed on their tablet, the workstation number can also be displayed on the marquee sign 306 located at the front of the mobile recruiter 130 and which time they would approach one of the available screeners 304 for a 10 to 15-minute face-to-face interview. Temp worker workstations 302 and screeners' workstations 304 can share data locally via a local area network, and externally via a cellular or other wireless connection shared across mobile recruiter 130.

After the interview process is completed, the screener 304 can upload temp worker's information to app system 100 and initiate background checks and vetting processes for the temp worker 102. The result of the vetting process can be available within 1 to 24 hours. The temp worker is notified of an acceptance or a denial. If accepted, the temp worker is instantly activated to begin accepting shifts that were booked by clients 101.

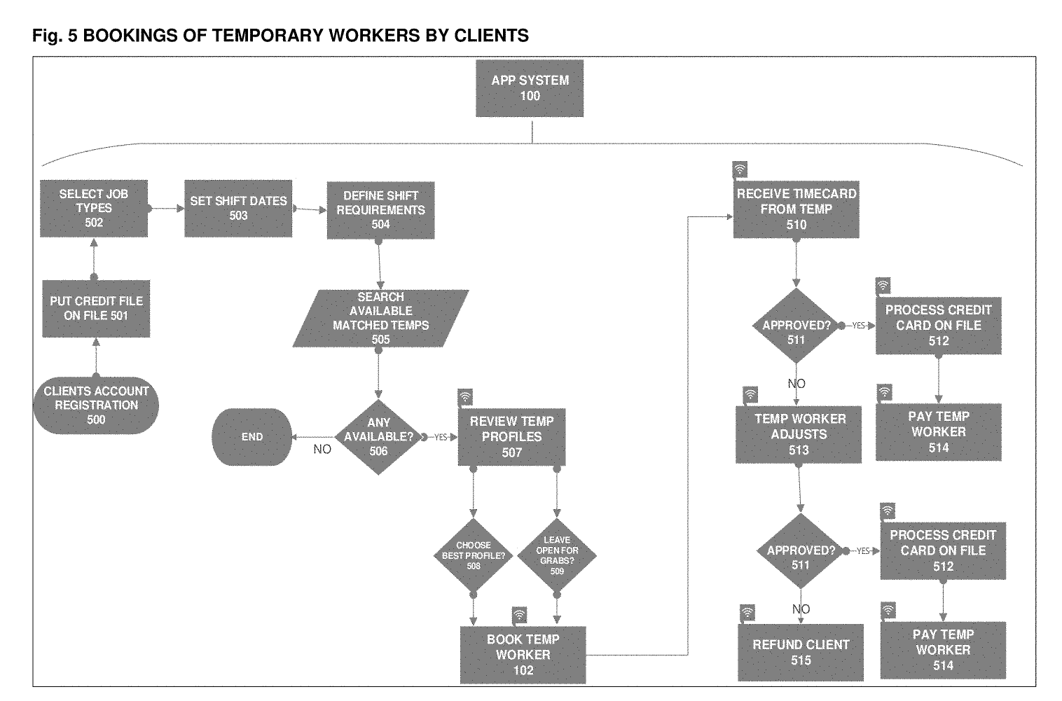

In order for clients to book temporary workers 102, client 500 can register an account on app system 100 as illustrated in FIG. 5. The registration process can keep a credit card 501 on file for booking transactions originated by client 500. App system 100 can facilitate Client 500 to set job types 502, define shift requirements 504 (such as shift start and end times, shift location, job description, additional specific task notes). App system 100 can provide client 500 with a list of matched temporary workers 102. App system 100 can enable client 500 to review each matched temporary worker 102. The system can give client 500 the option to select the best matched temporary worker 102 or leave open the selection of temporary worker 102. If client 500 chooses to leave open the selection of temporary workers 102, App system 100 can automatically notify all matched temporary workers within range of client 500. In such cases, the first available temporary worker 102 to respond to the notification locks the shift and thereby is booked by client 500.

After temporary worker 102 has completed a shift, a timecard 510 is initiated by the temporary worker 102 for review and approval by the client 500. If the timecard 510 is approved by client 500, the credit card 512 on file for client 500 is charged the amount of the agreed upon rate plus commission. The temporary worker 102 is paid 514. If the timecard 510 submitted for review and approval is not approved by client 500, the temporary worker 102 is notified by the App system 100 to correct any mistakes in the timecard 510 and it is resubmitted by App system 100 to client 500 for a second review and approval. If the timecard 510 is still not approved by client 500, the credit card 512 on file for client 500 can be refunded 515 or not charged for service rendered.

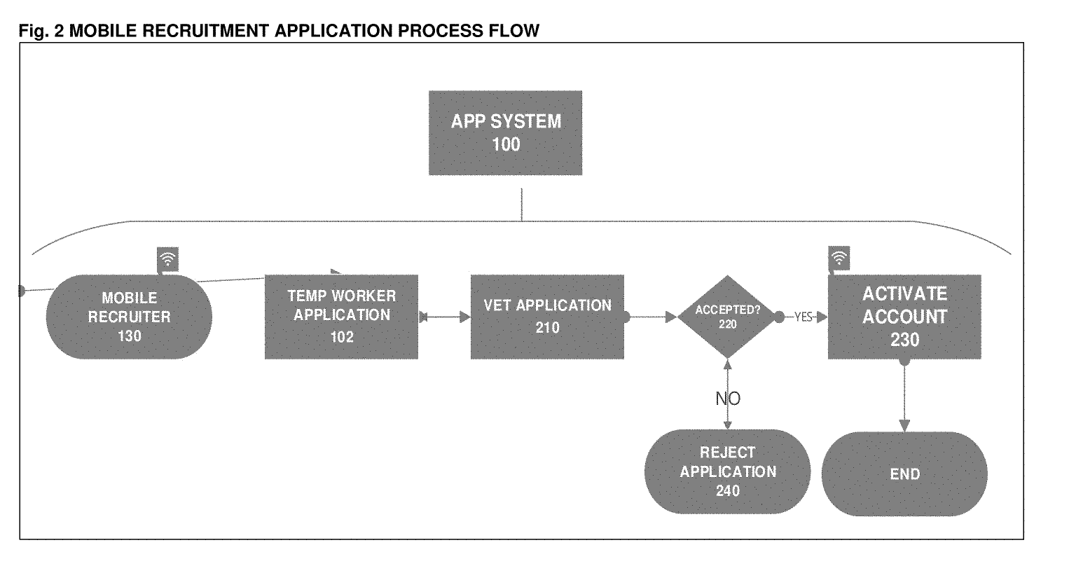

FIG. 2 illustrates how App system 100 can facilitate the mobile recruitment 130 of temporary worker 102 as the application process is completed. After the temporary worker 102 has boarded the mobile recruiter 130, an application can be completed at one of the workstations 302 on the mobile recruiter 130 on a tablet 301. The application process also requires the temporary worker 102 to scan 300 a state issued identification document for vetting process. Upon completing the application, App system 100 can require the temporary worker 102 watch a 5-minute orientation video explaining how to access temporary worker 102's portal. After the video, temporary worker 102's workstation 302 identification number can flash on the tablet 301 alerting the temporary worker 102 to approach a screener 308 at the front of the mobile recruiter 130 for a face-to-face interview lasting between 15-20 minutes. After the interview is completed, the temporary worker 102 can exit the mobile recruiter 130. The screener 308 can verified the application save to App system 100. An automated vetting 210 of the temporary worker 102 is then initiated by App system 100. Depending on the job type been recruited for, the vetting process of the temporary worker 102 may take between 1 hour to 24 hours to complete. If the application is accepted, the account of the temporary worker 102 is activated and the temporary worker 102 is notified of such action. From that moment onward, temporary worker 102 is ready to begin locking shifts 604.

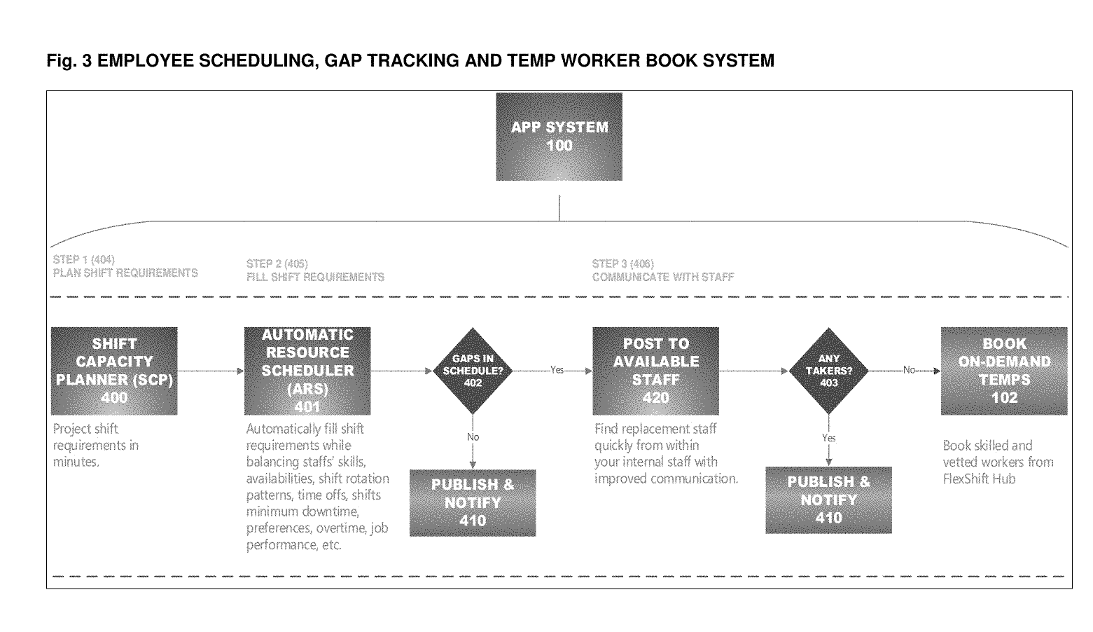

FIG. 3 illustrates the scheduling of clients 500 internal staff, identifying gaps in scheduling requirements and booking of temporary workers 102. In the scheduling module of App system 100, a client 500 can project scheduling shift requirements (SCP) 400, fill the scheduling shift requirements 400 with automatic resource scheduler (ARS) 401 with App system as a facilitator. If gaps 402 do not exist in the scheduling shift requirements 400, they are published to the internal staff as well as notified 410 of new scheduling shift requirements 400. If gaps 402 exists in the scheduling requirements, App system 100 can aide client 500 in posting the gaps 402 to available internal staff 420. If there are no takers 403, App system 100 can enable client 500 to book on-demand temporary workers 102 to bridge the gaps 402.

FIG. 4 illustrates the mobile recruiter 130 that consists of 20 to 40 workstations 302. The workstations 302 arranged to maximize space and comfort while enabling quick recruitment of temporary workers 102 by the mass. Each workstation is arranged facing the windows, tablets 301 and scanners 300 are positioned at each workstation 302. In front of the mobile recruiter are workstations 304 for 4 to 6 screeners 308. The screeners 308 oversee the operation of the mobile recruiter 130 and interviews of the temporary workers 102. All the workstations 302 & 304 are wired to a center WIFI Network on the mobile recruiter 130. Mobile recruiter 130 can be driven and parked at strategic locations e.g. malls, university campuses, unemployment offices, large events, etc. The mobile recruiter 130 can have company logos and marketing messages to attract both businesses (clients 500) and applicants (temporary workers 102). When the mobile recruiter 130 is parked and conducting recruitment of temporary workers 102, the mobile recruiter 130 can be powered by an auxiliary power generator located in the cargo bay area of the mobile recruiter 130. The mobile recruiter 130 can be equipped with a toilet, water system, air filtration system, air conditional and heating system. For mobile recruiter 130 operating in cold states, the mobile recruiter 130 can be configure with an interior door 307 that protects the main cabin of the mobile recruiter 130 from losing heat energy. When a temporary worker 102 boards the mobile recruiter 130 from the main entrance door, the interior door 307 can remain locked until the outside door is shut. The outside door of the mobile recruiter 130 is equipped with an automatic door open that allows the temporary workers 102 to board the mobile recruiter 130 while parked and without the assistant of the screeners 308.

Temporary Workers 102 seeking temporary shift assignments can board the mobile recruiter 130, locate an empty workstation, and take a 10-minutes online application, afterwards, the temporary workers 102 can watch a five-minute orientation video and lastly, approach one of screener's 308 workstations 304 located at the front of the bus for a ten-minute face-to-fact interview.

Once the interview is completed, App system 100 can enable the screeners 308 to transmit the applicant's application to the corporate office for further vetting 210 (e.g. electronic background checks). If time permits, the screeners 308 can initiate the electronic background checks (vetting 210) of the temporary workers 102. If the temporary workers 102 application is approved, the temporary workers 102 is instantly alerted via email and/or text messages with instructions on accessing the temporary workers 102 module on App system 100. The temporary workers 102 are ready to begin picking up shifts for which they're qualified at businesses (clients 500) that matches temporary workers 102 personal preference.

FIG. 5 illustrates the example of a browsing process in accordance with one embodiment. In the embodiment illustrated in FIG. 5, client 500 can book temporary worker 102 without first scheduling its internal staff, identifying gaps 402 in the scheduling shift requirements (SCP) 400 and converting those gaps 402 into temporary workers 102 bookings. The process for booking a temporary worker 102 can include client 500 registering and creating an account in App system 100 and store a credit card on file 501. App system 100 encrypts the credit cards 501 of client 500.

In one embodiment, client 500 selects from a list of job types 502 it normally hires its own staff, set the shift dates 503 requirements (e.g. start and end dates), defines the shift requirements (504) (e.g. shift locations, task descriptions, shift instructions, uniforms types to wear). App system 100 can identify and present available and matched 505 temporary workers 102 for client 500 to review. App system 100 can present the available and matched 505 temporary workers 102 by identifying temporary workers 102 whose total commute time falls into the range of the client 500 location of the shift. App system 100 then identifies and matches 505 the client 500's shift requirements with the temporary worker's 102 skills, primary job title, minimum hourly rates, none-shift intersection elsewhere, lead time to shift notification, language requirements, performance ratings.

App system 100 can then computes a FlexMatch Rating for the temporary worker 102 which enables and guide the client 500 to select the best and most reliable temporary worker 102. If there are one or more listings of available and matched 505 presented by App system 100, the client 500 can select one of the temporary workers 102 and book 508 the temporary worker 102 or leave the selection list open for grab 509. If left for grab 509, App system 100 can aide client 500 to blast the booking notification to all the available and matched 505 temporary workers 102. App system 100 can enable the first available and matched 505 temporary workers 102 to respond to the booking locks the shift thus completing the booking.

In one embodiment, after a temporary worker 102 has completed a shift, a timecard 510 is initiated by the temporary worker 102 for review and approval by the client 500. If the timecard 510 is approved by client 500, the credit card 512 on file for client 500 is charged the amount of the agreed upon rate plus commission. The temporary worker 102 is paid 514. If the timecard 510 submitted for review and approval is not approved by client 500, the temporary worker 102 is notified by the App system 100 to correct any mistakes in the timecard 510 and it is resubmitted by App system 100 to client 500 for a second review and approval. If the timecard 510 is still not approved by client 500, the credit card 512 on file for client 500 can be refunded 515 or not charged for service rendered.

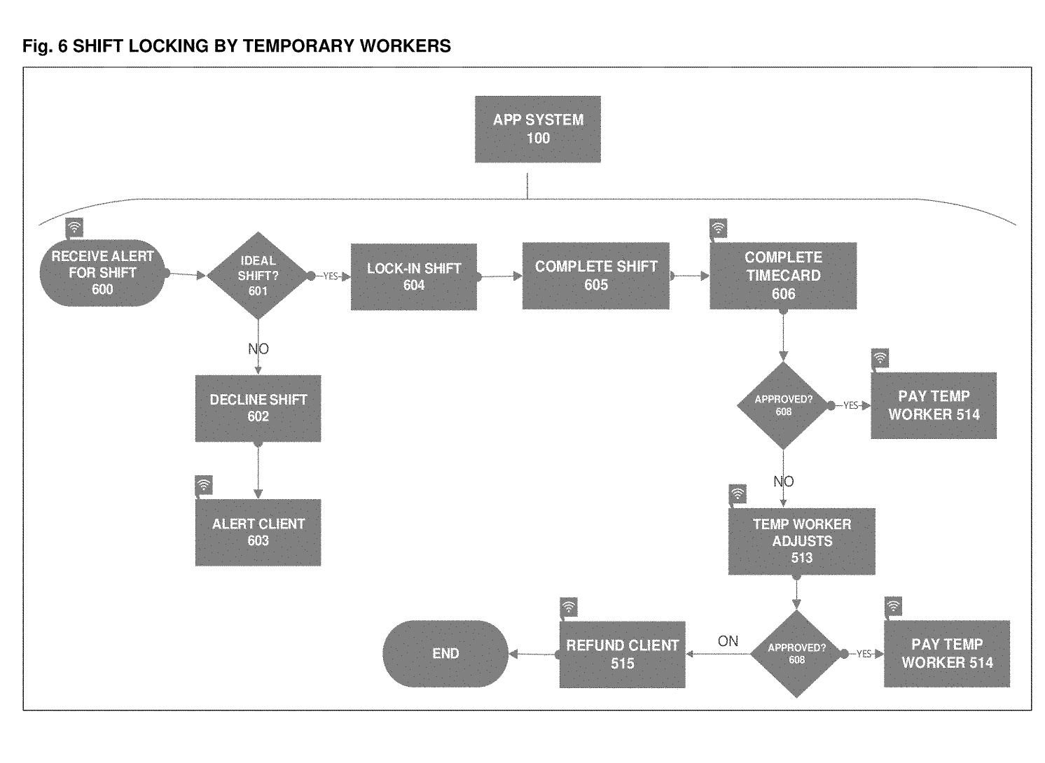

FIG. 6 illustrates the shift locking process by a temporary worker 102. App system 100 can improve efficiency and speed by aiding the temporary worker 102 to lock-in 604 a shift booking. App system 100 facilitates an alert 600 to a temporary worker 102 of possible shift opening. If the shift requirement is ideal 601 for the temporary worker 102, Apps system 102 enables the temporary worker 102 to lock-in 604 the shift. If the shift is not ideal 601 for the temporary worker 102, App system 100 enables the temporary worker 102 to decline 602 the shift, App system 100 then facilitates the transmission of an alert to client 500 alerting of the declined shift 602. App system 100 can then aide the client 500 to begin the booking process over again as illustrated in FIG. 5 of the embodiments.

In one embodiment, after the shift booking is completed 605 by the temporary worker 102, App system can enable the temporary worker 102 to transmit a timecard 606 to the client 500 for review and approval 608. If approved, App system 100 can facilitate payments 514 to the temporary worker 102. If the timecard 510 submitted for review and approval is not approved by client 500, the temporary worker 102 is notified by the App system 100 to correct any mistakes in the timecard 510 and it is resubmitted by App system 100 to client 500 for a second review and approval. If the timecard 510 is still not approved by client 500, the credit card 512 on file for client 500 can be refunded 515 or not charged for service rendered.

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, alignment or shape variations induced by thermal, rotational or vibrational operational conditions, and the like.

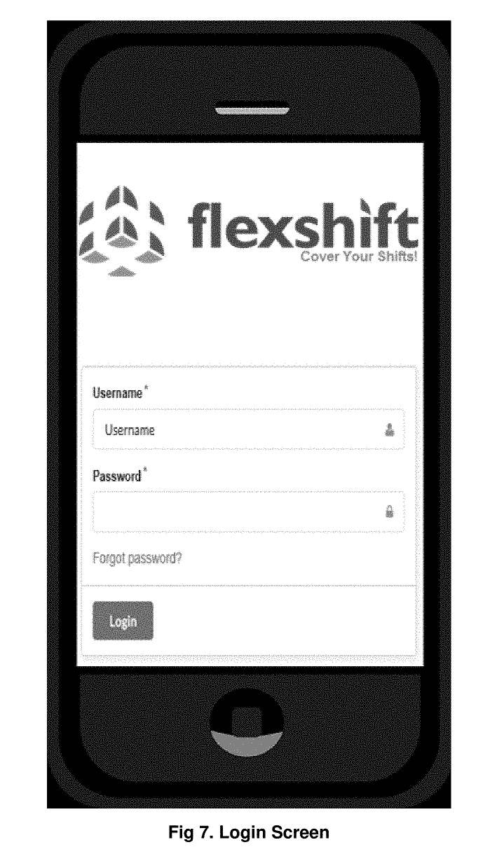

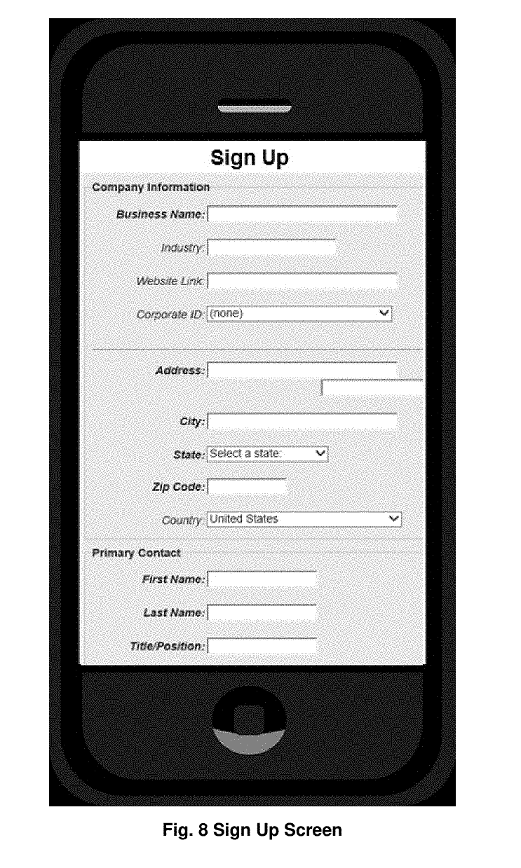

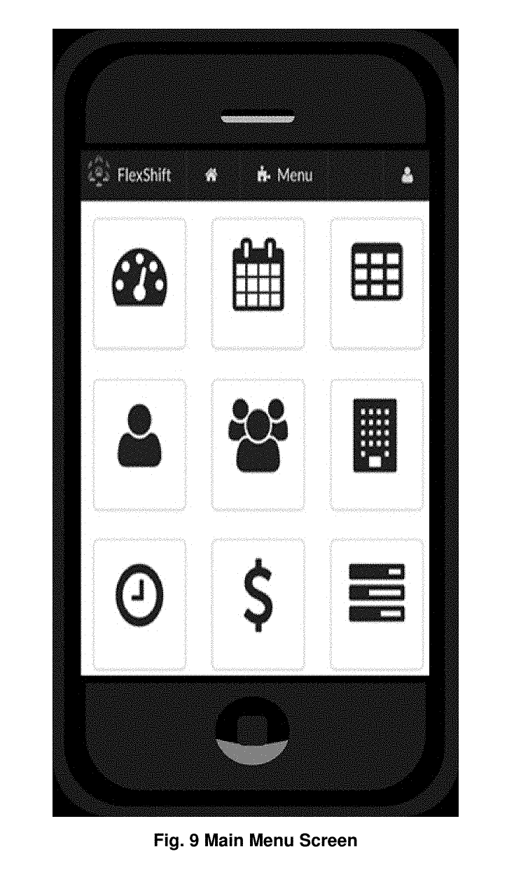

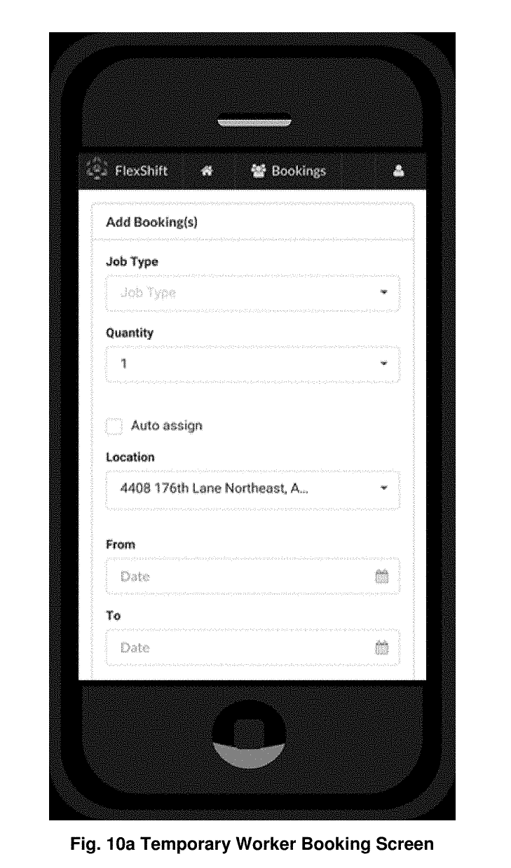

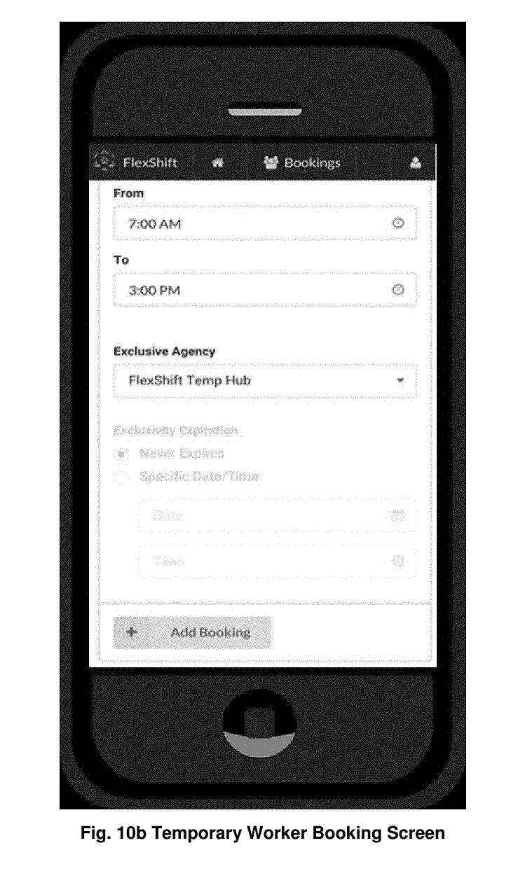

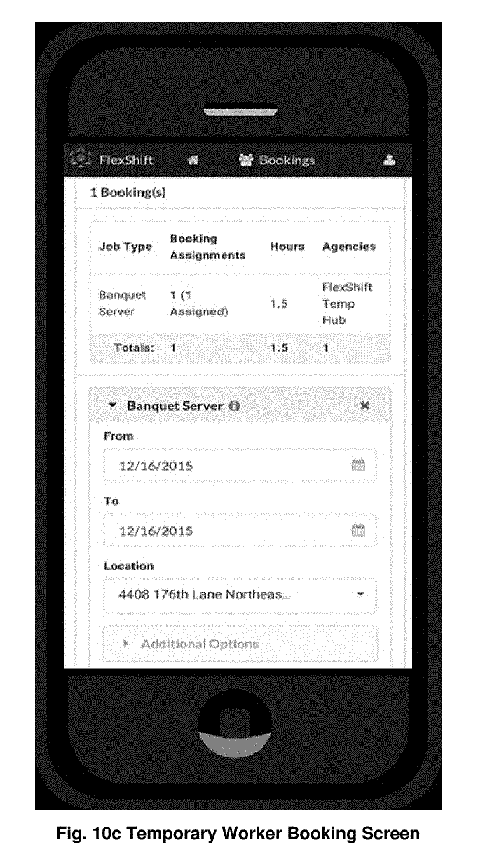

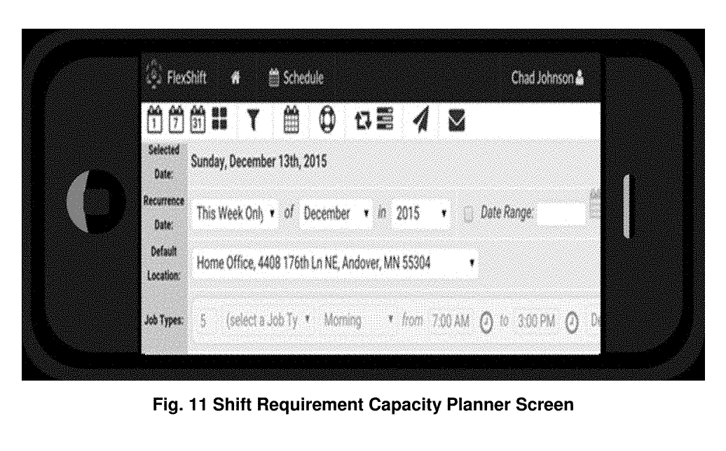

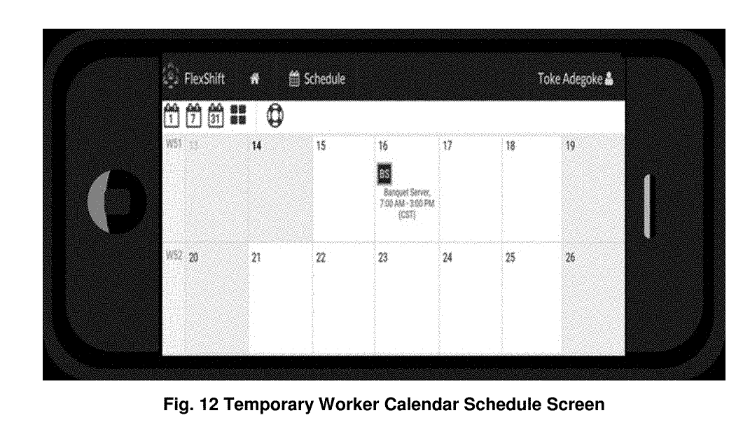

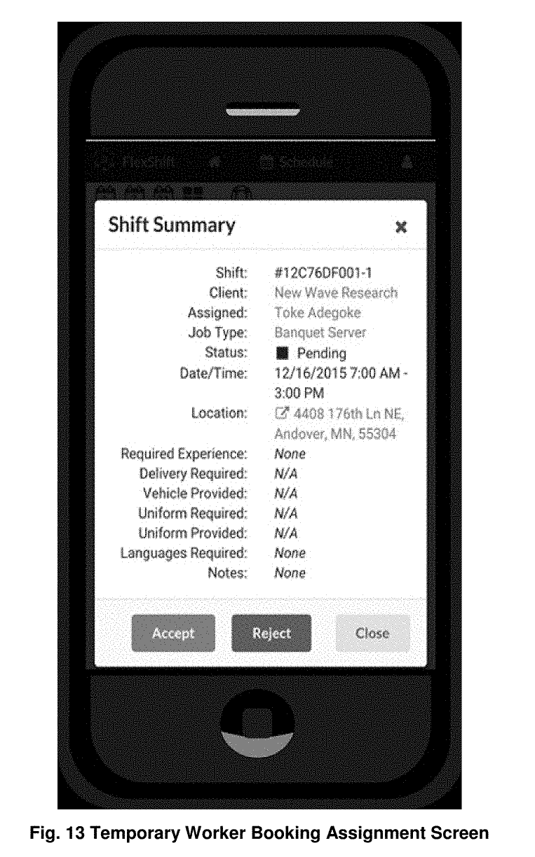

FIGS. 7-12 are screen schematics or screen captures of graphical user interfaces for use by clients with App system 100. FIG. 13 is a graphical user interface screen for use by temporary workers with App system 100.

While the invention has been described with reference to an exemplary embodiment(s), it can be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention can include all embodiments falling within the scope of the appended claims.

1. An application system comprising:
a client computing device;
a temporary worker computing device;
an online system connecting the client computing device and the temporary worker computing device; and
a mobile recruitment vehicle configured for conducting mass face-to-face recruiting of temporary workers and making the temporary workers readily available to clients for on-demand booking, the mobile recruitment vehicle including an applicant workstation configured to receive applicant data, and a screener workstation configured to retrieve background check information related to the temporary worker and provide authentication information configured to allow the client computing device to access the online system, based on the results of screening, the background check information, and the applicant data.

2. The application system of item 1, wherein the client computing device is configured to enable clients to project staffing capacity, fill the projection by creating employee schedules in real time, detect possible gaps in the projection after filling them, and automatically book temporary workers when needed to bridge the gaps, in response to detecting gaps.

3. The application system of item 1, wherein the client computing device is configured to enable the use of the app system as a standalone system to book temporary workers when needed to bridge scheduling gaps.

4. The application system of item 1, wherein the temporary worker computing device is configured to enable the use of the app system as a standalone to lock-in posted shifts.

5. A mobile temp worker recruitment system comprising:
a mobile recruitment vehicle with a main cabin and a remote wireless uplink;
a plurality of applicant workstations situated within the main cabin, each workstation being configured to collect an applicant data set comprising applicant identity, applicant qualifications, and applicant contact information;
a screener workstation situated within the main cabin, the screener workstation being configured to retrieve background check information about the applicant based on the applicant data set via the remote wireless uplink, and further configured to assemble and submit the applicant data set and a screener data set to a mobile app system via the remote wireless uplink, the screener data set comprising the background check information and a screener evaluation submitted via the screener workstation.

6. The mobile temp worker recruitment system of claim 5, wherein the main cabin facilitates in-person face-to-face interviews between a screener and the applicant at the screener workstation.

7. The mobile temp worker recruitment system of claim 5, wherein the screener workstation facilitates immediate real-time hiring and enrollment in an on-demand temp worker assignment mobile app, based on the screener data set and the applicant data set.

8. The mobile temp worker recruitment system of claim 5, wherein the applicant data set further comprises applicant identification in the form of a drivers' license or other authenticated credential.

9. A temp worker booking method, the method comprising:
relocating a mobile recruitment vehicle to an applicant location;
collecting applicant data via an applicant workstation on the mobile recruitment vehicle, the applicant data comprising applicant identity, applicant contact information, and applicant qualifications;
remotely retrieving background check information about the applicant based on the applicant data;
collecting a screener determination based on in-person face-to-face interview of the applicant;
providing the applicant with registration credentials for enrollment in a mobile system based on the applicant data and the screener determination;
collecting applicant preferences via the mobile system for at least one of payment method and notice requirements;
collecting client posting information via the mobile system specifying time, location, and type of temporary work positions; and
transmitting messages via the mobile system informing applicants of postings that fall within the applicant preferences, and wherein the applicant credentials match the type of temporary work position.
